(19) United States
(12) Patent Application Publication
(10) Pub. No.: US 2008/0098057 A1
(43) Pub. Date: Apr. 24, 2008

(54) Multiplication Apparatus

(76) Inventors: Daisuke Takeuchi, Osaka (JP); Kazufumi Tanoue, Osaka (JP)

Correspondence Address: MCDERMOTT WILL & EMERY LLP, 600 13TH STREET, NW, WASHINGTON, DC, 20005-3096, US

(21) Appl. No.: 11/661,145

(22) PCT Filed: Jul. 13, 2005
(86) PCT No.: PCT/JP05/12954

§ 371 Date: Feb. 26, 2007

(30) Foreign Application Priority Data
Aug. 26, 2004 (JP) 2004-246881

(51) Int. Cl. G06F 7/523; G06F 7/50

(52) U.S. Cl. 708/523

(57) ABSTRACT

There is provided a multiplication apparatus for generating a product of a multiplicand and a multiplier, each of which is a fixed point number represented in two's complement. The multiplication apparatus has an encoding unit for encoding the multiplier based on the radix-4 Booth's algorithm and outputting a plurality of encoding results obtained, an overflow detection unit for detecting an occurrence of an overflow when each of the multiplicand and the multiplier is a negative maximum value, and a partial product generation unit for generating a plurality of partial products from the multiplicand and the plurality of encoding results as well as a plurality of correction factors corresponding to the plurality of partial products and outputting the plurality of partial products and the plurality of correction factors. The partial product generation unit corrects any of the plurality of partial products and the plurality of correction factors such that a multiplication result has a positive maximum value and outputting the result of the correction when the overflow detection unit detects the occurrence of the overflow.

### TECHNICAL FIELD

The present invention relates to an apparatus for performing multiplication and, more particularly, to an apparatus for performing multiplication of fixed point numbers.

### BACKGROUND ART

It is normal practice to provide an LSI which performs a digital arithmetic operation process with an on-chip multiplication apparatus. In the processing of audio data, multimedia data, or the like which requires a high-precision arithmetic operation, the arithmetic operation is performed with fixed point numbers. When the result of multiplication overflows, it is required to perform a saturation process. In the multiplication of fixed point numbers, the multiplication result overflows only when each of a multiplicand and a multiplier is a negative maximum value. In this case, it is necessary to correct the multiplication result to a positive maximum value. The negative maximum value mentioned herein is a negative value having a maximum absolute value.

FIG. 15 is a block diagram showing an example of a structure of a conventional multiplication apparatus. When multiplication is performed in this multiplication apparatus, an overflow detection unit 914 detects an overflow when each of a multiplicand and a multiplier is a negative maximum value. When the overflow is detected, an output selector 926 selects a saturation value (positive maximum value). In the other cases, an output of a final addition unit 924 is selected, whereby correction when the multiplication result overflows is implemented (see, e.g., Patent Document 1).

Patent Document 1: Japanese Laid-Open Patent Publication No. 1-267728 (FIG. 3).

### DISCLOSURE OF THE INVENTION

### Problem to be Solved by the Invention

In a multiplication apparatus as shown in FIG. 15, to select either one of the result of final addition and the saturation value, a selector is needed for each of bits. In the multiplication of an (M+1)-bit multiplicand and an (N+1)-bit multiplier B (where each of M and N is an integer of not less than 2), when each of the multiplicand A and the multiplier B is a signed number, the multiplication result is in (M+N+1) bits. Accordingly, (M+N+1) selectors are needed as the output selectors and there is the problem of an increase in the scale of a circuit for overflow processing.

An object of the present invention is to reduce the scale of the circuit for overflow processing.

### Means for Solving the Problem

The present invention is a multiplication apparatus for generating a product of a multiplicand, which is a fixed point number represented in two's complement, and a multiplier, which is a fixed point number represented in two's complement, the multiplication apparatus comprising: an encoding unit for encoding the multiplier based on a radix-4 Booth's algorithm and outputting a plurality of encoding results obtained; an overflow detection unit for detecting an occurrence of an overflow when each of the multiplicand and the multiplier is a negative maximum value; a partial product generation unit for generating a plurality of partial products from the multiplicand and the plurality of encoding results as well as a plurality of correction factors, which correspond to the plurality of individual partial products, to be added to the corresponding partial products and provide respective two's complements of the partial products and outputting the plurality of partial products and the plurality of correction factors; an accumulation unit for performing accumulation of the plurality of partial products and the plurality of correction factors, compressing a result of the accumulation to two intermediate products, and outputting the two intermediate products; and a final addition unit for performing addition of the two intermediate products and outputting the result of the addition as a multiplication result, wherein the partial product generation unit corrects any of the plurality of partial products and the plurality of correction factors such that the multiplication result has a positive maximum value and outputs a result of the correction when the overflow detection unit detects the occurrence of the overflow.

As a result, when each of the multiplicand and the multiplier is the negative maximum value, namely, when the occurrence of the overflow is detected, it is possible to set the multiplication result to the positive maximum value by correcting the output of the partial product generation unit. Even when the overflow occurs, the scale of a circuit required for overflow processing can be reduced because it is unnecessary to perform a process with respect to the obtained multiplication result.

Preferably, in the multiplication apparatus mentioned above, the multiplier is an (N+1)-bit (where N is an integer of not less than 2) number, wherein the partial product generation unit includes: a plurality of first partial product generation circuits for individually receiving the plurality of encoding results except for the most significant and least significant encoding results and performing, based on the multiplicand and the received encoding results, the generation of each of the plurality of partial products corresponding to the received encoding results except for the most significant and least significant partial products and the generation of each of the plurality of correction factors corresponding to the received encoding results except for the most significant and least significant correction factors; a second partial product generation circuit for performing, based on the multiplicand and the most significant encoding result of the plurality of encoding results, the generation of the most significant partial product of the plurality of partial products and the generation of the most significant correction factor of the plurality of correction factors; and a third partial product generation circuit for performing, based on the multiplicand and the least significant encoding result of the plurality of encoding results, the generation of the least significant partial product of the plurality of partial products and the generation of the least significant correction factor of the plurality of correction factors, wherein the second partial product generation circuit outputs 0 as the most significant correction factor when the occurrence of the overflow is detected by the overflow detection unit, and wherein the third partial product generation circuit outputs 1 as each of lower (N−1) bits of the least significant partial product when the occurrence of the overflow is detected by the overflow detection unit.

As a result, when the occurrence of the overflow is detected, it is possible to set the multiplication result to the positive maximum value by outputting 0 as the most significant correction factor and outputting 1 as each of the lower (N−1) bits of the least significant partial product. This allows a reduction in the scale of the circuit required for overflow processing.

Preferably, the third partial product generation circuit includes: a plurality of selection circuits each for generating one bit of the least significant partial product in response to the multiplicand and to a selection signal; and an encoding result correction unit, wherein an output of the encoding result correction unit is given as the selection signal to each of the (N−1) selection circuits of the plurality of selection circuits which output the lower (N−1) bits of the least significant partial product, while the least significant encoding result is given as the selection signal to each of the other selection circuits, and wherein the encoding result correction unit outputs a value such that 1 is outputted from each of the selection circuits to which the output of the encoding result correction unit is given in a case where the occurrence of the overflow is detected by the overflow detection unit, while outputting the least significant encoding result in the other cases.

As a result, it is sufficient to add the encoding result correction unit for correcting the result of encoding when the occurrence of the overflow is detected to the third partial product generation circuit.

Preferably, the third partial product generation circuit includes: a plurality of selection circuits each for generating one bit of the least significant partial product in response to the multiplicand and to a selection signal; and (N−1) saturation processing circuits corresponding to the respective (N−1) selection circuits of the plurality of selection circuits which output the lower (N−1) bits of the least significant partial product, wherein each of the plurality of selection circuits uses the least significant encoding result as the selection signal, and wherein each of the (N−1) saturation processing circuits corrects an output of the corresponding selection circuit of the plurality of selection circuits to 1 and outputs the corrected value in a case where the occurrence of the overflow is detected by the overflow detection unit, while outputting the output of the corresponding selection circuit as it is in the other cases.

As a result, it is sufficient to add the (N−1) saturation processing circuits for correcting the least significant partial product when the occurrence of the overflow is detected to the third partial product generation circuit.

Preferably, in the multiplication apparatus mentioned above, the partial product generation unit includes: a plurality of first partial product generation circuits for individually receiving the plurality of encoding results except for the most significant encoding result and performing, based on the multiplicand and the received encoding results, the generation of each of the plurality of partial products corresponding to the received encoding results except for the most significant partial product and the generation of each of the plurality of correction factors corresponding to the received encoding results except for the most significant correction factor; and a second partial product generation circuit for performing, based on the multiplicand and the most significant encoding result of the plurality of encoding results, the generation of the most significant partial product of the plurality of partial products and the generation of the most significant correction factor of the plurality of correction factors, wherein each of the plurality of first partial product generation circuits outputs a binary number 11 as each of the correction factors to be generated except for the most significant correction factor when the occurrence of the overflow is detected by the overflow detection unit, and wherein the second partial product generation circuit outputs 0 as the most significant correction factor when the occurrence of the overflow is detected by the overflow detection unit.

As a result, when the occurrence of the overflow is detected, it is possible to set the multiplication result to the positive maximum value by outputting 0 as the most significant correction factor and outputting the binary number 11 as each of the correction factors except for the most significant correction factor. In the case of encoding the (N+1)-bit multiplier based on the radix-4 Booth's algorithm, the number of the correction factors is (N+1)/2 so that (N+1)/2 circuits are needed for correcting the correction factors. However, compared with the conventional structure, the scale of the circuit required for overflow processing can be reduced.

Preferably, in the multiplication apparatus mentioned above, the partial product generation unit includes: a plurality of first partial product generation circuit for individually receiving the plurality of encoding results except for the most significant encoding result and performing, based on the multiplicand and the received encoding results, the generation of each of the plurality of partial products corresponding to the received encoding results except for the most significant partial product and the generation of each of the plurality of correction factors corresponding to the received encoding results except for the most significant correction factor; and a second partial product generation circuit for performing, based on the multiplicand and the most significant encoding result of the plurality of encoding results, the generation of the most significant partial product of the plurality of partial products and the generation of the most significant correction factor of the plurality of correction factors, wherein each of the plurality of first partial product generation circuits outputs a binary number 11 as the lower two bits of each of the partial products except for the most significant partial product to be generated when the occurrence of the overflow is detected by the overflow detection unit, and wherein the second partial product generation circuit outputs 0 as the most significant correction factor when the occurrence of the overflow is detected by the overflow detection unit.

As a result, when the occurrence of the overflow is detected, it is possible to set the multiplication result to the positive maximum value by outputting 0 as the most significant correction factor and outputting the binary number 11 as each of the partial products except for the most significant partial product. This allows a reduction in the scale of the circuit required for overflow processing.

Preferably, each of the plurality of first partial product generation circuits includes: a plurality of selection circuits each for generating one bit of the partial product outputted from the first partial product generation circuit in response to the multiplicand and to a selection signal; and an encoding result correction unit, wherein an output of the encoding result correction unit is given as the selection signal to each of the two of the plurality of selection circuits which output the lower two bits of the partial product, while the received encoding result is given as the selection signal to each of the other selection circuits, and wherein the encoding result correction unit outputs a value such that 1 is outputted from each of the selection circuits to which the output of the encoding result correction unit is given in a case where the occurrence of the overflow is detected by the overflow detection unit, while outputting the received encoding result in the other cases.

As a result, it is sufficient to add the encoding result correction unit for correcting the result of encoding when the occurrence of the overflow is detected to each of the first partial product generation circuits. In the case of encoding the (N+1)-bit multiplier based on the radix-4 Booth's algorithm, the number of the partial products generated by the plurality of first partial product generation circuits is (N+1)/2−1 so that the ((N+1)/2−1) encoding result correction units are needed. However, compared with the conventional structure, the scale of the circuit required for overflow processing can be reduced.

Preferably, each of the plurality of first partial product generation circuits includes: a plurality of selection circuits each for generating one bit of the partial product outputted from the first partial product generation circuit in response to the multiplicand and to the received encoding result; and two saturation processing circuits respectively corresponding to the two of the plurality of selection circuits which output the lower two bits of the partial product, wherein each of the two saturation processing circuits corrects an output of the corresponding one of the two selection circuits to 1 and outputs the corrected value when the occurrence of the overflow is detected by the overflow detection unit, while outputting the output of the corresponding selection circuit as it is in the other cases.

As a result, it is sufficient to add the two saturation processing circuits for correcting the partial product when the occurrence of the overflow is detected to each of the first partial product generation circuits. In the case of encoding the (N+1)-bit multiplier based on the radix-4 Booth's algorithm, the number of the partial products generated by the plurality of first partial product generation circuits is ((N+1)/2−1 so that the (((N+1)/2−1)*2=N−1) saturation processing circuits are needed. However, compared with the conventional structure, the scale of the circuit required for overflow processing can be reduced.

Preferably, in the multiplication apparatus mentioned above, the partial product generation unit includes: a plurality of first partial product generation circuits for individually receiving the plurality of encoding results except for the most significant encoding result and performing, based on the multiplicand and the received encoding results, the generation of each of the plurality of partial products corresponding to the received encoding results except for the most significant partial product and the generation of each of the plurality of correction factors corresponding to the received encoding results except for the most significant correction factor; and a second partial product generation circuit for performing, based on the multiplicand and the most significant encoding result of the plurality of encoding results, the generation of the most significant partial product of the plurality of partial products and the generation of the most significant correction factor of the plurality of correction factors, wherein each of the plurality of first partial product generation circuits outputs 1 as the second least significant bit of each of the partial products except for the most significant partial product to be generated and outputs 1 as each of the correction factors except for the most significant correction factor to be generated when the occurrence of the overflow is detected by the overflow detection unit, and wherein the second partial product generation circuit outputs 0 as the most significant correction factor when the occurrence of the overflow is detected by the overflow detection unit.

As a result, when the occurrence of the overflow is detected, it is possible to set the multiplication result to the positive maximum value by outputting 0 as the most significant correction factor, outputting 1 as the second least significant bit of each of the partial products except for the most significant partial product, and outputting 1 as each of the correction factors except for the most significant correction factor. In the case of encoding the (N+1)-bit multiplier based on the radix-4 Booth's algorithm, each of the respective numbers of the partial products and the correction factors generated by the plurality of first partial product generation circuits is (N+1)/2−1 so that (1+((N+1)/2−1)*2=N) circuits functioning as the selectors are needed. However, compared with the conventional structure, the scale of the circuit required for overflow processing can be reduced.

### EFFECT OF THE INVENTION

Thus, according to the present invention, the scale of the circuit for performing a process when the result of multiplication of fixed point numbers overflows can be reduced. As a result, it is possible to reduce the area of the circuit and reduce the cost of the circuit.

### BRIEF DESCRIPTION OF THE DRAWINGS

FIG. 1 is a block diagram showing a structure of a multiplication apparatus according to a first embodiment of the present invention;

FIG. 2 is a circuit diagram showing a structure of a first partial product generation circuit in the first embodiment;

FIG. 3 is a circuit diagram showing a structure of a second partial product generation circuit in the first embodiment;

FIG. 4 is a circuit diagram showing a structure of a third partial product generation circuit in the first embodiment;

FIG. 5 is an illustrative view showing a calculation example of multiplication in the first embodiment;

FIG. 6 is a circuit diagram showing another example of the structure of the third partial product generation circuit;

FIG. 7 is a circuit diagram showing a structure of a first partial product generation circuit according to a second embodiment of the present invention;

FIG. 8 is an illustrative view showing a calculation example of multiplication in the second embodiment;

FIG. 9 is a circuit diagram showing a structure of a first partial product generation circuit according to a third embodiment of the present invention;

FIG. 10 is an illustrative view showing a calculation example of multiplication in the third embodiment;

FIG. 11 is a circuit diagram showing a variation of the first partial product generation circuit of FIG. 9;

FIG. 12 is a circuit diagram showing a structure of a first partial product generation circuit according to a fourth embodiment of the present invention;

FIG. 13 is an illustrative view showing a calculation example of multiplication in the fourth embodiment;

FIG. 14 is a block diagram showing a structure of a multiply-accumulate operation apparatus according to a fifth embodiment of the present invention; and

FIG. 15 is a block diagram showing an example of a structure of a conventional multiplication apparatus.

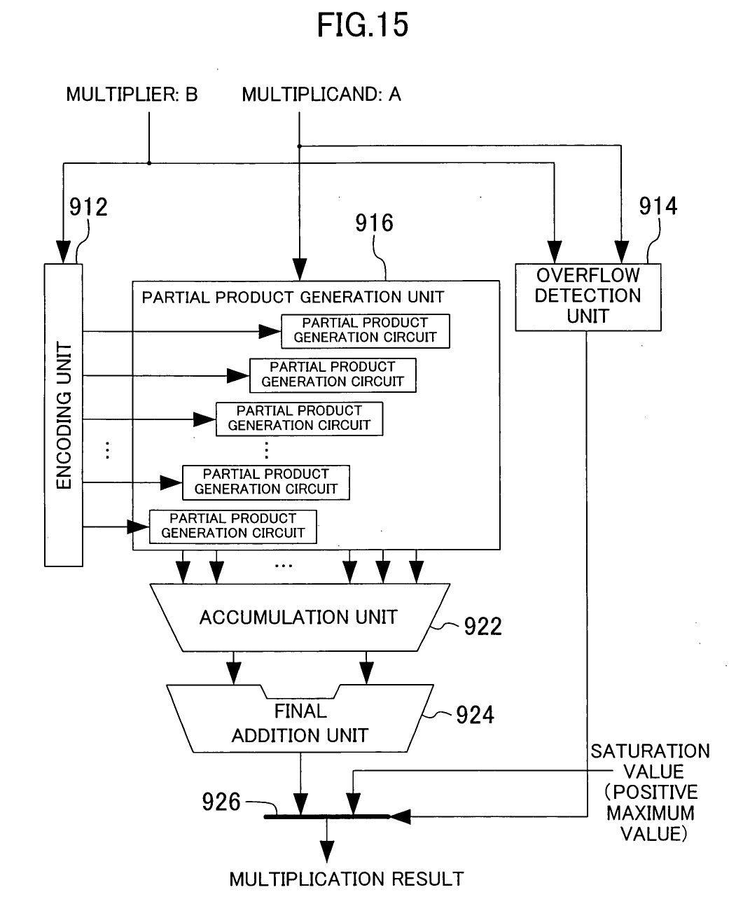

### DESCRIPTION OF NUMERALS

12, 712 Encoding Unit
14 Overflow Detection Unit
16 Partial Product Generation Unit
22 Accumulation Unit
24 Final Addition Unit
32 Fixed Point Shift Unit
34 Carry save addition Unit
36 Ripple Carry Addition Unit
38 Selector
140, 340, 440, 540, 640 First Partial Product Generation Circuit
142, 144 Selection Circuit
146, 166, 346, 646 Correction Factor Generation Circuit
160 Second Partial Product Generation Circuit
180, 280 Third Partial Product Generation Circuit
188 Encoding Result Correction Unit
231 Saturation Processing Circuit

### BEST MODE FOR CARRYING OUT THE INVENTION

Referring to the drawings, the embodiments of the present invention will be described herein below.

### Embodiment 1

A description will be given hereinafter to the case where the multiplication of an (M+1)-bit multiplicand A and an (N+1)-bit multiplier B is performed (where each of M and N is an integer of not less than 2). It is assumed herein that each of the multiplicand A and the multiplier B is a signed fixed point number represented in two's complement notation, a decimal point exists on the right side of the most significant bit thereof, and the most significant bit represents a positive or negative sign. In the fixed-point number system, a positive maximum value is 0.99 . . . 9 (the value of each bit is “011 . . . 11”) and a negative maximum value is a negative number having a maximum absolute value, which is −1.00 . . . 0 (the value of each bit is “100 . . . 00”).

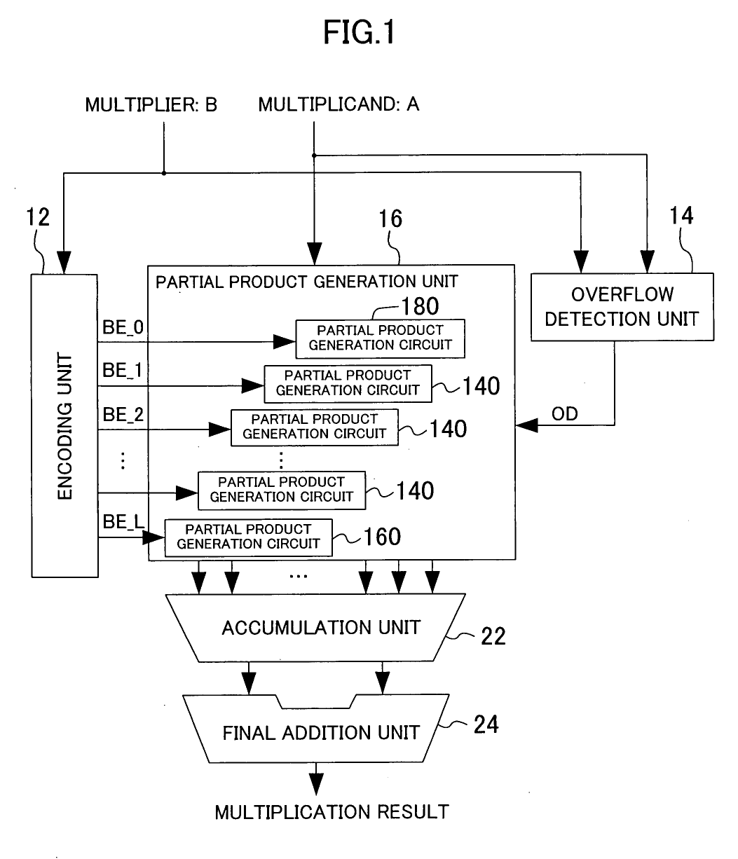

FIG. 1 is a block diagram showing a structure of a multiplication apparatus according to the first embodiment of the present invention. The multiplication apparatus of FIG. 1 comprises an encoding unit 12, an overflow detection unit 14, a partial product generation unit 16, an accumulation unit 22, and a final addition unit 24.

The encoding unit 12 encodes the (N+1)-bit multiplier B based on the radix-4 Booth's algorithm and outputs the obtained Booth's encoding results BE_0, BE_1, and BE_L to the partial product generation unit 16. The Booth's encoding results BE_0 and BE_L are the least significant and most significant Booth's encoding results, respectively.

The overflow detection unit 14 detects the occurrence of an overflow when each of the multiplicand A and the multiplier B is the negative maximum value and outputs the result as an overflow detection result OD to the partial product generation unit 16.

The partial product generation unit 16 generates a plurality of partial products from the multiplicand A and the individual Booth's encoding results BE_0, BE_1, . . . and BE_L as well as correction factors corresponding to these partial products and outputs them to the accumulation unit 22. When the overflow detection unit 14 detects the occurrence of an overflow, the partial product generation unit 16 corrects any of the plurality of partial products and the correction factors such that the multiplication result has the positive maximum value and outputs them. The accumulation unit 22 performs the accumulation of the plurality of generated partial products and the generated correction factors, compresses the result of accumulation to two intermediate products, and outputs them to the final addition unit 24. The final addition unit 24 performs the addition of the two intermediate products and outputs the obtained multiplication result.

The partial product generation unit 16 comprises a plurality of first partial product generation circuits 140 for generating the partial products except for the most significant and least significant partial products as well as the correction factors corresponding to these partial products, a second partial product generation circuit 160 for generating the most significant partial product and the most significant correction factor, and a third partial product generation circuit 180 for generating the least significant partial product and the least significant correction factor. Each of the partial products mentioned herein is a partial product before the correction factor is added thereto to provide a two's complement. Each of the correction factors is a number added to the corresponding partial product to provide the two's complement of the partial product.

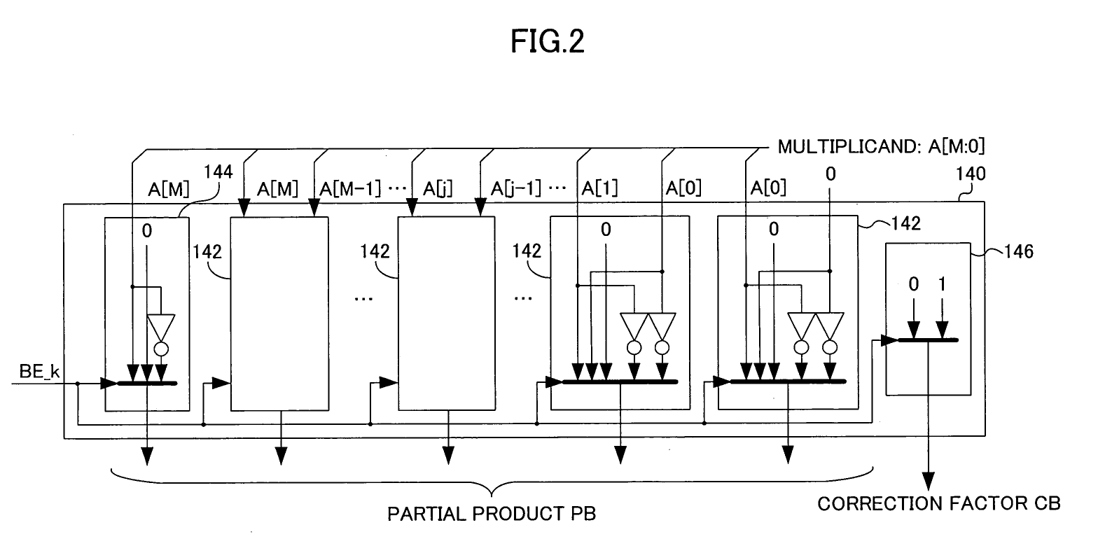

FIG. 2 is a circuit diagram showing a structure of each of the first partial product generation circuits 140 in the first embodiment. The partial product generation circuit 140 of FIG. 2 obtains a partial product PB and a correction factor CB based on one (denoted as BE_k) of the Booth's encoding results BE_1, BE_2, . . . , and BE_L−1 except for the most significant and least significant Booth's encoding results and outputs them. The partial product generation circuit 140 comprises (M+1) selection circuits 142 for generating the bits of the partial product PB other than the most significant bit, a selection circuit 144 for generating the most significant bit of the partial product PB, and a correction factor generation circuit 146.

These selection circuits 142 and 144 as a whole select the multiplicand A when the Booth's encoding result BE_k is 1, select a value obtained by left-shifting the multiplicand A by 1 bit when the Booth's encoding result BE_k is 2, select a value obtained by logically inverting each of the bits of the multiplicand A when the Booth's encoding result BE_k is −1, select a value obtained by logically inverting each of the bits of the value obtained by left-shifting the multiplicand A by 1 bit when the Booth's encoding result BE_k is −2, and select “0” when the Booth's encoding result BE_k is 0 and outputs the selected value. The correction factor generation circuit 146 selects “0” as the correction factor CB for a two's complement when the Booth's encoding result BE_k is positive or 0 and selects “1” as the correction factor CB for a two's complement when the Booth's encoding result BE_k is negative and outputs the selected value.

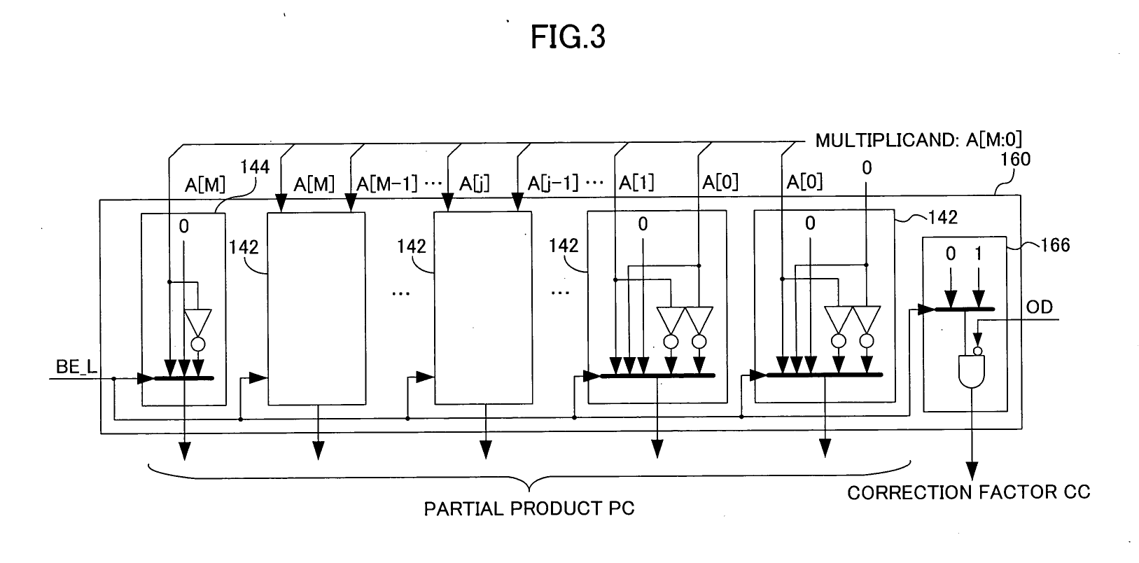

FIG. 3 is a circuit diagram showing a structure of the second partial product generation circuit 160 in the first embodiment. The partial product generation circuit 160 of FIG. 3 obtains a partial product PC and a correction factor CC based on the most significant Booth's encoding result BE_L and outputs them. The partial product generation circuit 160 is constructed similarly to the first partial product generation circuit 140 of FIG. 1 except that it comprises a correction factor generation circuit 166 in place of the correction factor generation circuit 146.

The overflow detection unit 14 sets the overflow detection result OD to “1” on detecting that each of the multiplicand A and the multiplier B is the negative maximum value, while setting the overflow detection result OD to “0” in the other cases. When the overflow detection result OD is “1”, the correction factor generation circuit 166 outputs “0” as the correction factor CC for a two's complement. When the overflow detection result OD is “0” and the Booth's encoding result BE_L is positive or 0, the correction factor generation circuit 166 selects “0” as the correction factor CC for a two's complement and outputs “0”. When the overflow detection result OD is “0” and the Booth's encoding result BE_L is negative, the correction factor generation circuit 166 selects “1” as the correction factor CC for a two's complement and outputs “1”.

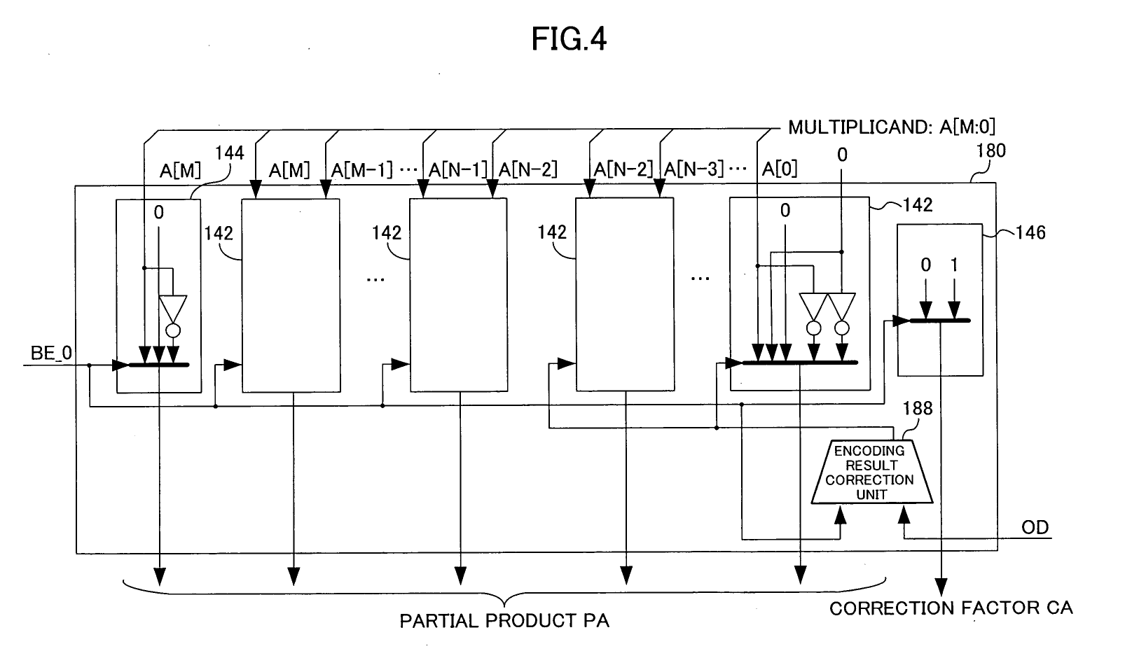

FIG. 4 is a circuit diagram showing a structure of the third partial product generation circuit 180 in the first embodiment. The partial product generation circuit 180 of FIG. 4 obtains a partial product PA and a correction factor CA based on the least significant Booth's encoding result BE_0 and outputs them. The partial product generation circuit 180 further comprises an encoding result correction unit 188 in addition to the components of the first partial product generation circuit 140 of FIG. 2 and is adapted to give an output of the encoding result correction unit 188, not the Booth's encoding result BE_0, to the lower (N−1) selection circuits 142.

When the overflow detection result OD is “1”, the encoding result correction unit 188 corrects the Booth's encoding result BE_0 to “−1” and outputs “−1” to the lower (N−1) selection circuits 142. When the overflow detection result OD is “0”, the encoding result correction unit 188 outputs the Booth's encoding result BE_0 as it is. The lower (N−1) selection circuits 142 generate the partial product based on the multiplicand A and the output of the encoding result correction unit 188 and output it. The selection circuits 142 higher than the lower (N−1) selection circuits 142 generate the partial product based on the multiplicand A and the Booth's encoding result BE_0 and output it.

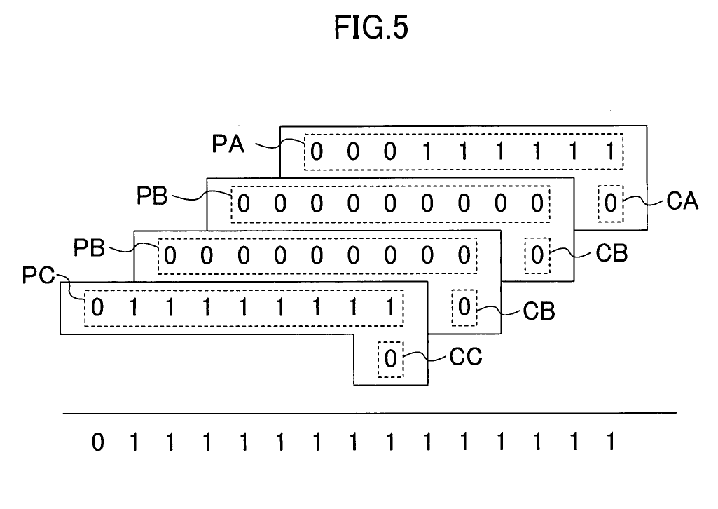

FIG. 5 is an illustrative view showing a calculation example of multiplication in the first embodiment. A description will be given herein below on the assumption that each of the numbers of bits (M+1) and (N+1) of the multiplicand A and the multiplier B is 8. The description will be given to the case where it is detected that each of the multiplicand A and the multiplier B is the negative maximum value. In this case, each of the multiplicand A and the multiplier B is specifically “10000000”.

When the multiplier B is the negative maximum value, each of the Booth's encoding results BE_k except for the most significant and least significant Booth's encoding results is 0. As a result, each of the first partial product generation circuits 140 outputs “000000000” as the partial product PB and outputs “0” as the correction factor CB.

When the multiplier B is the negative maximum value, the most significant Booth's encoding result BE_L is −2 and the second partial product generation circuit 160 outputs “011111111” as the partial product PC. Since the overflow detection result OD is “1”, the correction factor CC for a two's complement is corrected to a value “0” by the correction factor generation circuit 166.

When the multiplier B is the negative maximum value, the least significant Booth's encoding result BE_0 is 0. Since the overflow detection result OD is “1”, the encoding result correction unit 188 corrects the Booth's encoding result BE_0 to “−1”. As a result, each of the lower six selection circuits 142 selects the value obtained by logically inverting the multiplicand A and outputs “1” as each of the lower 6 bits. In short, the third partial product generation circuit 180 outputs “000111111” as the partial product PA and outputs “0” as the correction factor CA.

Therefore, when each of the multiplicand A and the multiplier B is the negative maximum value, “011111111111111” is outputted from the final addition unit 24, as shown in FIG. 5. That is, the final addition unit 24 outputs the multiplication resulted corrected to the positive maximum value and a value close to the precise product of the multiplicand A and the multiplier B can be obtained.

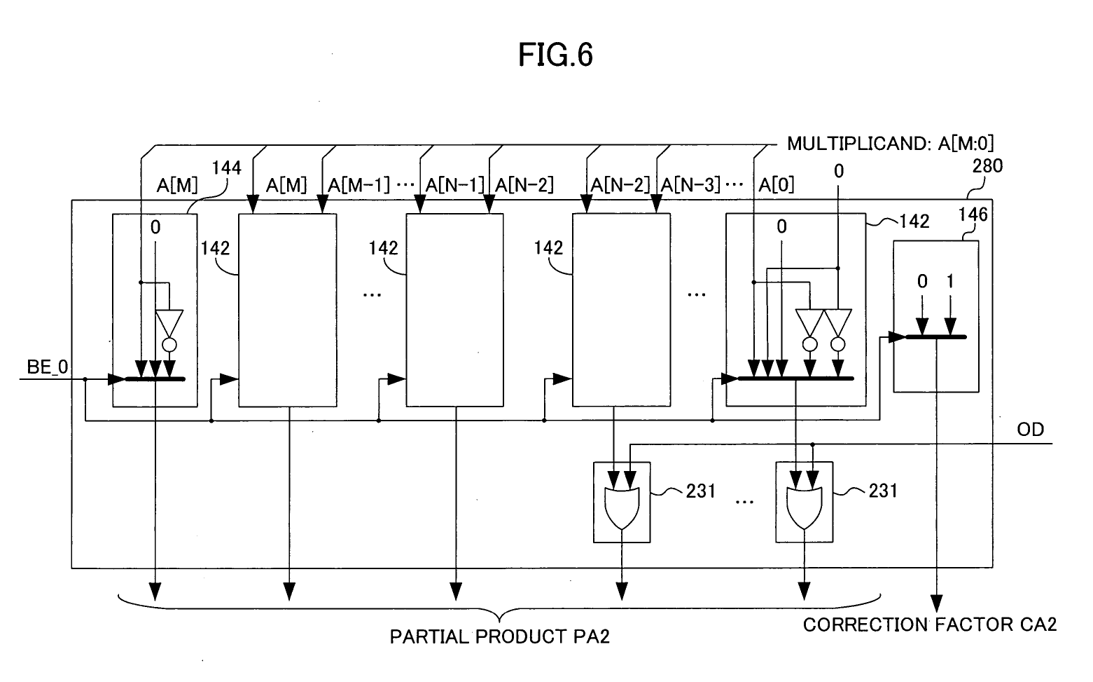

FIG. 6 is a circuit diagram showing another example of the structure of the third partial product generation circuit. A partial product generation circuit 280 of FIG. 6 further comprises (N−1) saturation processing circuits 231 in addition to the components of the partial product generation circuit 140 of FIG. 2. The saturation processing circuits 231 are, e.g., OR gates.

The (N−1) saturation processing circuits 231 correspond to the respective lower (N−1) selection circuits 142. The lower (N−1) selection circuits 142 give the outputs thereof to the corresponding saturation processing circuits 231. Each of the saturation processing circuits 231 outputs “1” when the overflow detection result OD is “1”, while outputting an output of the corresponding selection circuit 142 as it is in the other cases.

When each of the multiplicand A and the multiplier B is the negative maximum value, a partial product PA2 outputted from the partial product generation circuit 280 is “000111111” so that, even when the partial product generation circuit 280 of FIG. 6 is used in place of the partial product generation circuit 180, the same multiplication result is obtained.

### Embodiment 2

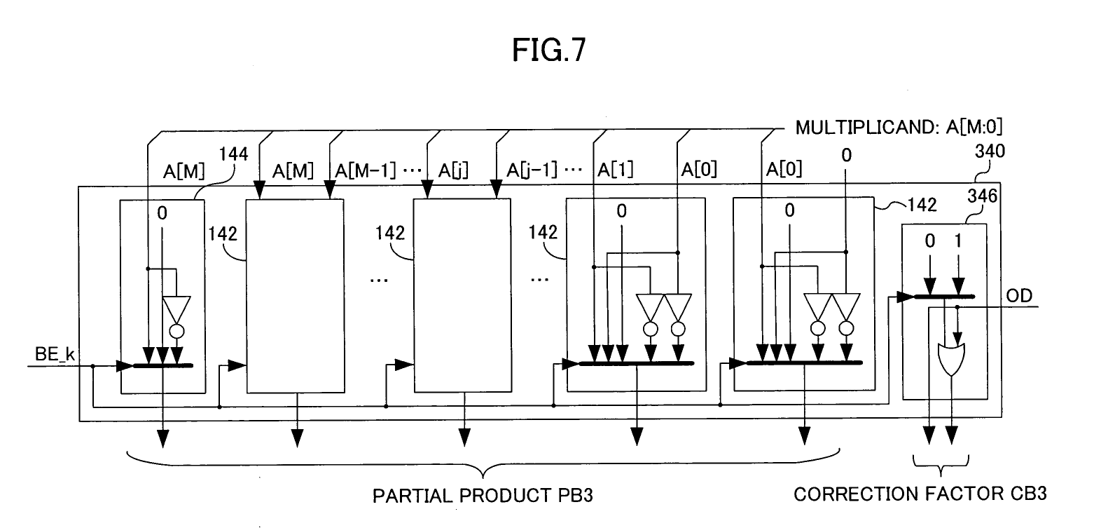

FIG. 7 is a circuit diagram showing a structure of each of first partial product generation circuits 340 according to the second embodiment of the present invention. The partial product generation circuit 340 of FIG. 7 comprises a correction factor generation circuit 346 in place of the correction factor generation circuit 146 in the partial product generation circuit 140 of FIG. 2. In the second embodiment, it is assumed that the Booth's encoding results BE_k show the Booth's encoding results except for the most significant Booth's encoding result.

The second embodiment uses the partial product generation circuits 340 in place of the partial product generation circuits 140 and 180 in the multiplication apparatus of FIG. 1. As for the other components, they are the same as the components described in the first embodiment so that the description thereof is omitted.

When the overflow detection result OD is “1”, the correction factor generation circuit 346 outputs a binary number “11” as a correction factor CB3 for a two's complement. When the overflow detection result OD is “0” and the Booth's encoding result BE_0 or BE_k is either positive or 0, the correction factor generation circuit 346 selects “00” as the correction factor CB3 for a two's complement and outputs “00”. When the overflow detection result OD is “0” and the Booth's encoding result BE_0 or BE_k is negative, the correction factor generation circuit 346 selects “01” as the correction factor CB3 for a two's complement and outputs “01”. A partial product PB3 outputted from the partial product generation circuit 340 is the same as the partial product PB outputted from the partial product generation circuit 140 of FIG. 2.

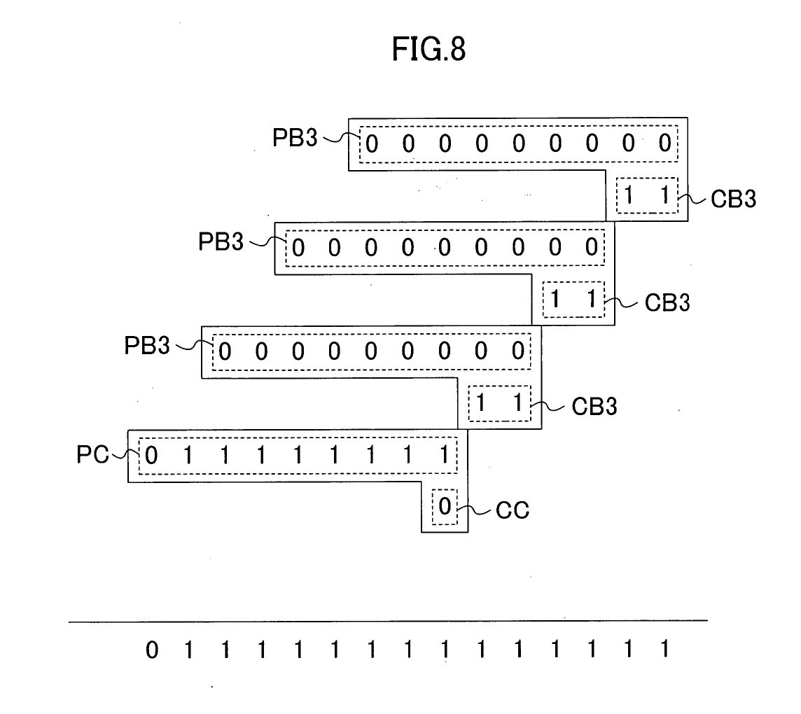

FIG. 8 is an illustrative view showing a calculation example of multiplication in the second embodiment. A description will be given to the case where it is detected that each of the multiplicand A and the multiplier B is the negative maximum value. In this case, the partial product PB3 outputted from each of the partial product generation circuits 340 is “000000000”. On the other hand, each of the correction factor generation circuits 346 outputs “11” as the correction factor CB3. As a result, the multiplication result obtained through the addition of the partial products PB3 and PC and the correction factors CB3 and CC is corrected to the positive maximum value and outputted, as shown in FIG. 8.

### Embodiment 3

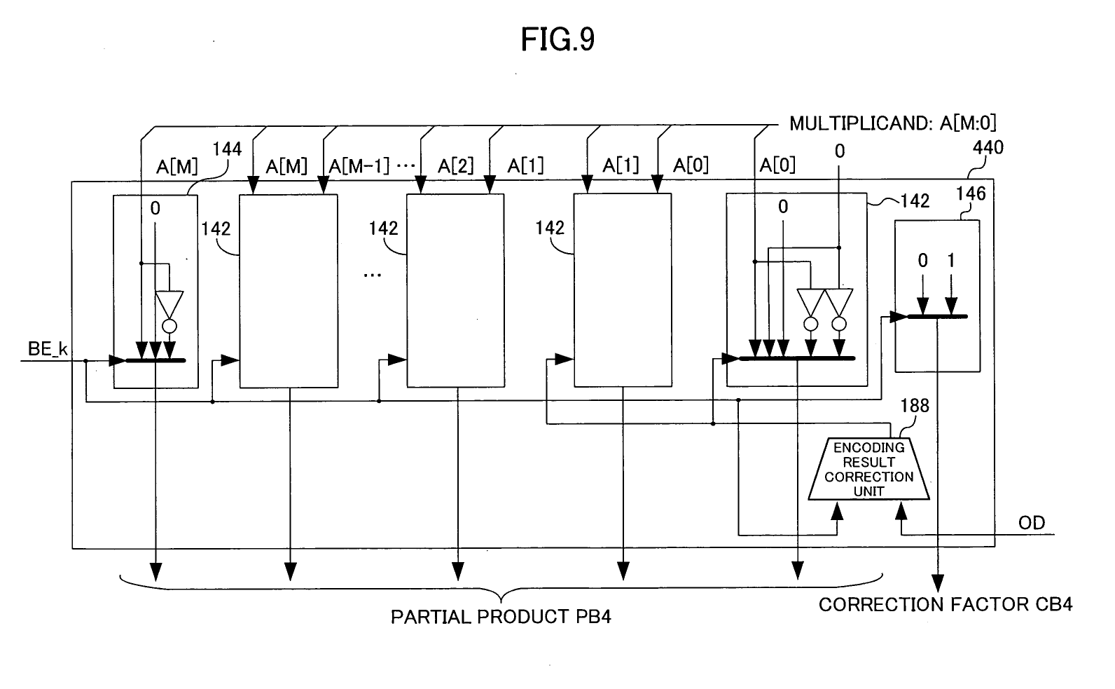

FIG. 9 is a circuit diagram showing a structure of each of first partial product generation circuits 440 according to the third embodiment of the present invention. The partial product generation circuit 440 of FIG. 9 is obtained by adapting the partial product generation circuit 180 of FIG. 4 such that the output of the encoding result correction unit 188, not the Booth's encoding result BE_k, is given to each of the least and second least significant two selection circuits 142, while the Booth's encoding result BE_k is given to each of the selection circuits 142 higher than the least and second least significant selection circuits 142. In the third embodiment, it is assumed that the Booth's encoding results BE_k show the Booth's encoding results except for the most significant Booth's encoding result.

The third embodiment uses the partial product generation circuits 440 in place of the partial product generation circuits 140 and 180 in the multiplication apparatus of FIG. 1. As for the other components, they are the same as described in the first embodiment so that the description thereof is omitted.

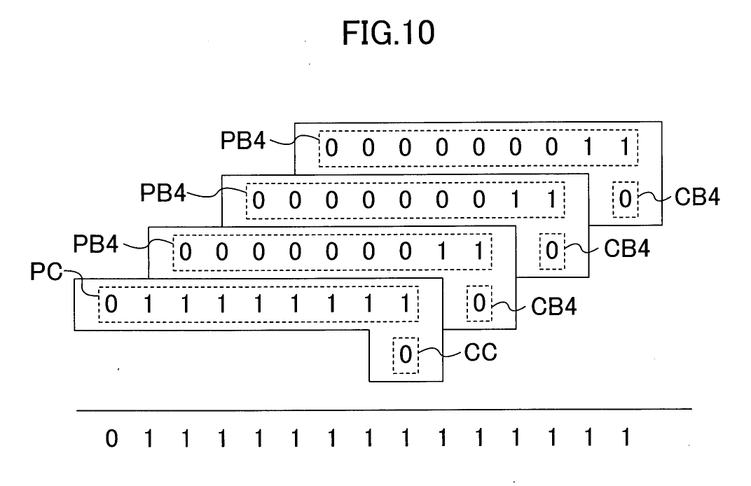

FIG. 10 is an illustrative view showing a calculation example of multiplication in the third embodiment. A description will be given to the case where it is detected that each of the multiplicand A and the multiplier B is the negative maximum value. In this case, the Booth's encoding results BE_k other than the most significant Booth's encoding result of the multiplier B is “0”. Because the overflow detection result OD is “1”, the encoding result correction unit 188 corrects each of the Booth's encoding results BE_k to “−1”. In response to this, the least and second least significant two selection circuits 142 select the values obtained by logically inverting the corresponding bits of the multiplicand A so that each of the partial product generation circuits 440 outputs “000000011” as a partial products PB4 and outputs “0” as a correction factor CB4. As a result, the multiplication result obtained through the addition of the partial products PB4 and PB and the correction factors CB4 and CC is corrected to the positive maximum value and outputted.

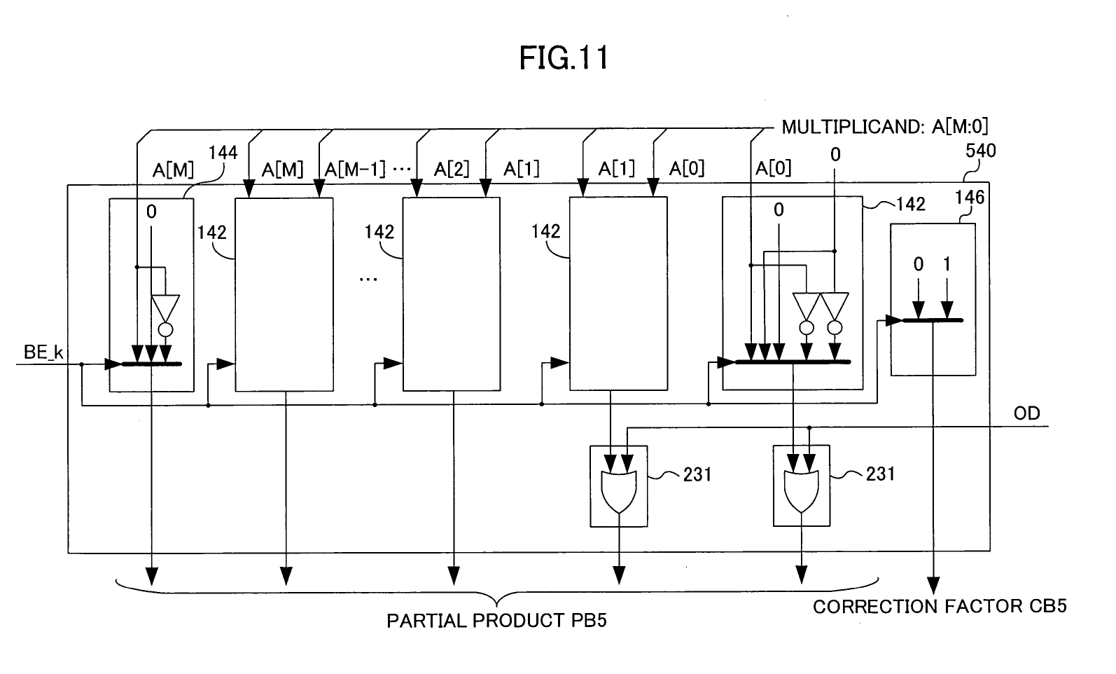

FIG. 11 is a circuit diagram showing a variation of the first partial product generation circuit of FIG. 9. A partial product generation circuit 540 of FIG. 11 further comprises two saturation processing circuits 231 in addition to the components of the partial product generation circuit 140 of FIG. 2. The saturation processing circuits 231 are, e.g., OR gates.

The two saturation processing circuits 231 respectively correspond to the least and second least significant two selection circuits 142. The least and second least significant two selection circuits 142 give the respective outputs thereof to the corresponding saturation processing circuits 231. Each of the saturation processing circuits 231 outputs “1” when the overflow detection result OD is “1” and outputs the output of the corresponding selection circuit 142 as it is when the overflow detection result OD is “0”.

When it is detected that each of the multiplicand A and the multiplier B is the negative maximum value, each of the partial product generation circuits 540 outputs “000000011” as a partial product PB5 so that, even when the partial product generation circuit 540 of FIG. 11 is used in place of the partial product generation circuit 440 of FIG. 9, the same multiplication result is obtained.

### Embodiment 4

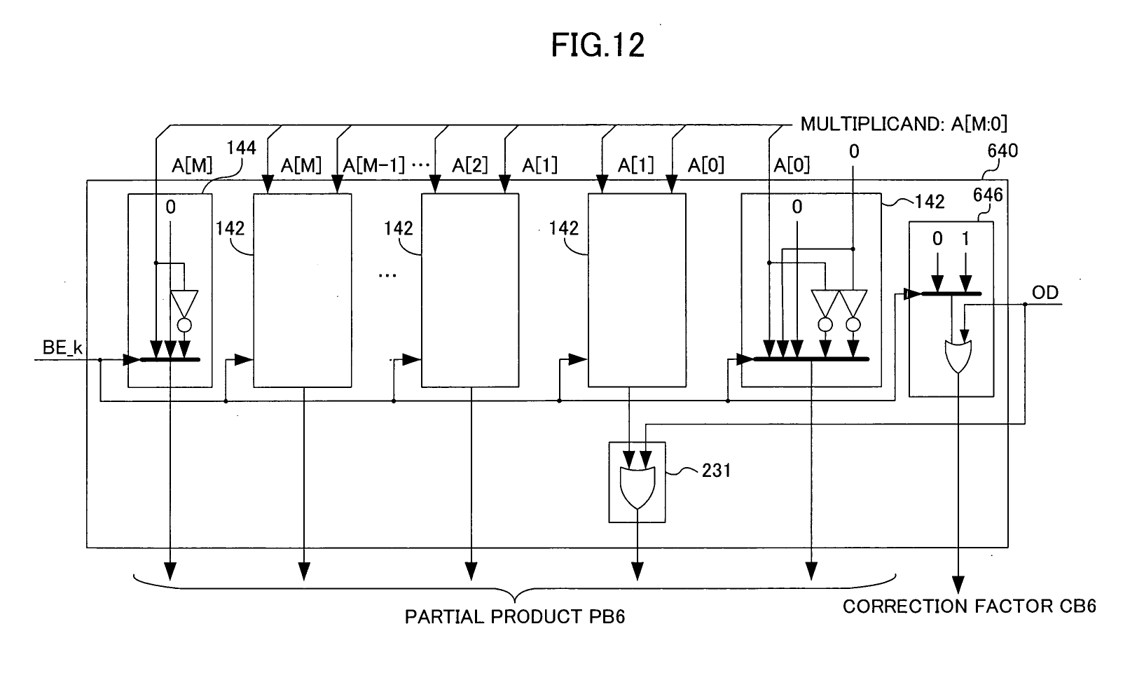

FIG. 12 shows a structure of each of partial product generation circuits 640 according to the fourth embodiment of the present invention. The partial product generation circuit 640 of FIG. 12 is different from the partial product generation circuit 140 of FIG. 2 in that a correction factor generation circuit 646 is provided instead of the correction factor generation circuit 146, and a saturation processing circuit 231 is further provided. The saturation processing circuit 231 is, e.g., an OR gate. In the fourth embodiment, it is assumed that the Booth's encoding results BE_k show the Booth's encoding results other than the most significant Booth's encoding result.

The second least significant selection circuit 142 gives the output thereof to the saturation processing circuit 231. The saturation processing circuit 231 outputs “1” when the overflow detection result OD is “1”, while outputting the output of the second least significant selection circuit 142 as it is when the overflow detection result OD is “0”. The correction factor generation circuit 646 outputs “1” as a correction factor CB6 when the overflow detection result OD is “1”, while outputting the same value as outputted from the correction factor generation circuit 146 of FIG. 2 as the correction factor CB6 when the overflow detection result OD is “0”.

The fourth embodiment uses the partial product generation circuits 640 in place of the partial product generation circuits 140 and 180 of the multiplication apparatus of FIG. 1. As for the other components, they are the same as the components described in the first embodiment so that the description thereof is omitted.

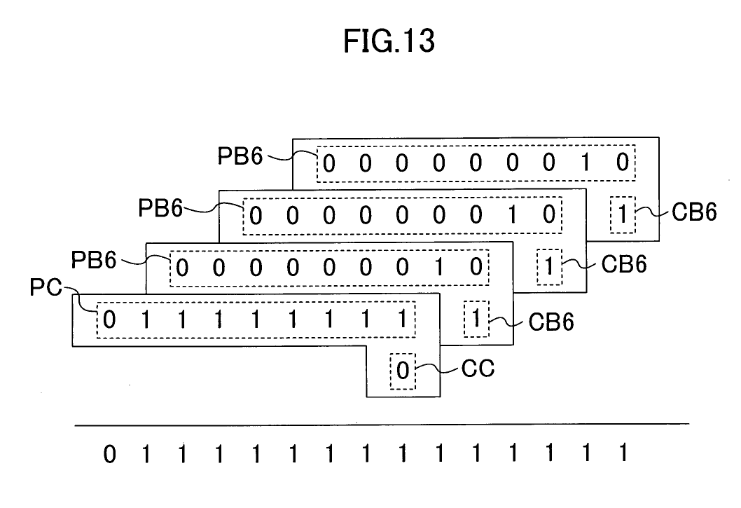

FIG. 13 is an illustrative view showing a calculation example of multiplication in the fourth embodiment. A description will be given to the case where it is detected that each of the multiplicand A and the multiplier B is the negative maximum value. In this case, the Booth's encoding results BE_k other than the most significant Booth's encoding result of the multiplier B is 0. Since the overflow detection result OD is “1”, each of the correction factor generation circuit 646 and the saturation processing circuits 231 outputs “1”. That is, each of the partial product generation circuits 640 outputs “000000010” as a partial product PB6 and outputs “1” as a correction factor CB6. As a result, the multiplication result obtained through the addition of the partial products PB6 and PB and the correction factors CB6 and CC is corrected to the positive maximum value and outputted, as shown in FIG. 13.

### Embodiment 5

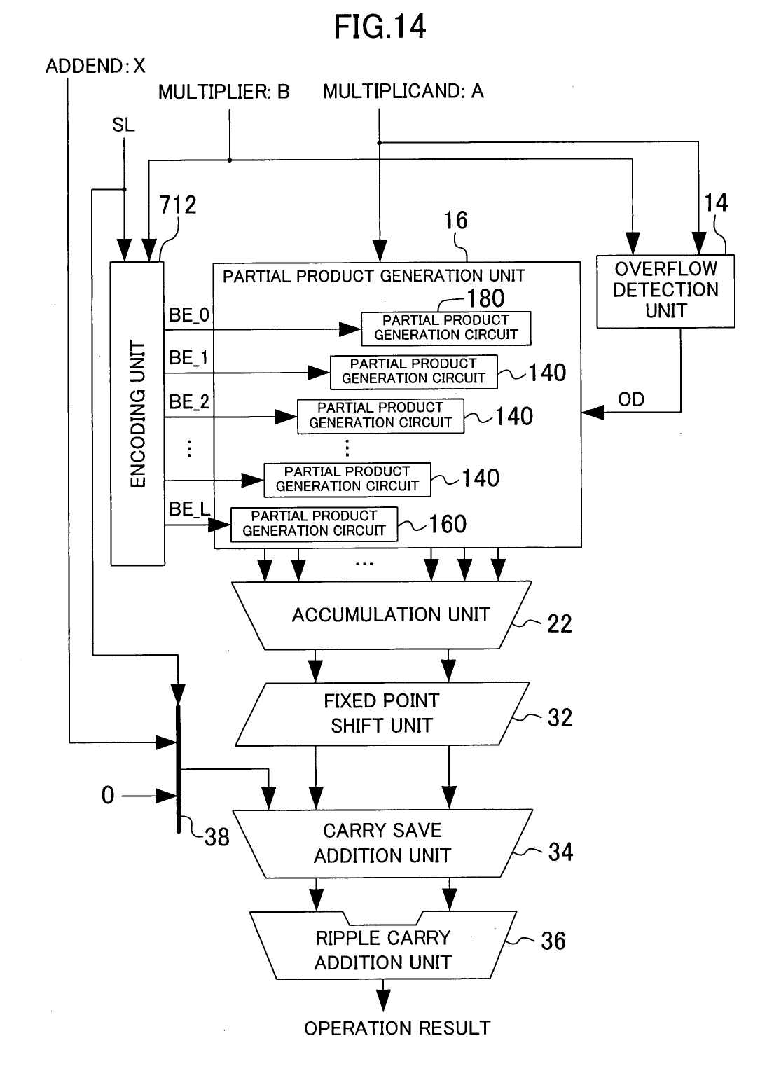

In the present embodiment, a multiply-accumulate operation apparatus obtained by modifying the multiplication apparatus of FIG. 1 will be described. FIG. 14 is a block diagram showing a structure of the multiply-accumulate operation apparatus according to the fifth embodiment of the present invention.

The multiply-accumulate operation apparatus of FIG. 14 determines the sum of, or the difference between, an addend X and the product of an (M+1)-bit multiplicand A and an (N+1)-bit multiplier B. In short, the multiply-accumulate operation apparatus implements an arithmetic operation of X±A×B. It is assumed herein that the addend X is a signed fixed point number represented in two's complement notation, a decimal point exists on the right side of the most significant bit, and the most significant bit represents a positive or negative sign.

The multiply-accumulate operation apparatus of FIG. 14 comprises: an encoding unit 712; an overflow detection unit 14; a partial product generation unit 16; an accumulation unit 22; a fixed point shift unit 32; a carry save addition unit 34; a ripple carry addition unit 36; and a selector 38. As for the overflow detection unit 14, the partial product generation unit 16, and the accumulation unit 22, they are the same as described with reference to FIG. 1 so that the description thereof is omitted.

When an operation selection signal SL indicates that a multiply-accumulate operation is to be performed, the encoding unit 712 encodes the multiplier B based on the radix-4 Booth's algorithm and outputs the obtained Booth's encoding results BE_0, BE_1, . . . , and BE_L to the partial product generation unit 16, similarly to the encoding unit 12 of FIG. 1. When the operation selection signal SL indicates that a multiply-subtract operation is to be performed, the encoding unit 712 encodes the multiplier B based on the radix-4 Booth's algorithm and outputs the two's complements of the obtained results as the Booth's encoding results BE_0, BE_1, . . . , and BE_L to the partial product generation unit 16.

The fixed point shift unit 32 shifts the intermediate products outputted from the accumulation unit 22 such that each of the decimal-point positions therein is aligned with the decimal point in the addend X and outputs the result of shifting to the carry save addition unit 34. When the operation selection signal SL indicates that the multiply-accumulate operation of the multiply-subtract operation is to be performed, the selector 38 selects the addend X, while selecting “0” in the other cases, and outputs the selected number to the carry save addition unit 34. When “0” is selected, the multiply-accumulate operation apparatus of FIG. 14 performs multiplication (A×B).

The carry save addition unit 34 performs the carry save addition of the output of the selector 38 and the two intermediate products outputted from the fixed point shift unit 32 to obtain the two intermediate products and outputs them to the ripple carry addition unit 36. The ripple carry addition unit 36 performs the addition of the inputted two intermediate products and outputs the obtained operation result.

Thus, with the multiply-accumulate operation apparatus of FIG. 14, the multiply-accumulate operation, the multiply-subtract operation, or the multiplication can be performed in response to the operation selection signal SL.

It is to be noted that, in place of the partial product generation circuits 140, 160, and 180, the other partial product generation circuits described in the first to fourth embodiments may also be used.

Thus, in each of the multiplication apparatus and the multiply-accumulate operation apparatus according to the present invention, when it is detected that each of the multiplicand A and the multiplier B is the negative maximum value, the partial product generation unit performs correction with respect to the partial products or the correction factors such that the multiplication result has the positive maximum value. Since a process for handling an overflow is not performed with respect to the obtained multiplication result, the circuit scale can be reduced.

### INDUSTRIAL APPLICABILITY

Since the present invention can reduce the scale of a circuit which performs a process when the result of multiplication of fixed point numbers overflows, it is useful as a multiplier. In particular, the present invention is useful as a multiplier or a multiply-accumulate operation element embedded in a processor for processing audio data, media data, or the like which needs fixed-point arithmetic to implement a high-precision arithmetic operation.

1-9. (canceled)

10. A multiplication apparatus for generating a product of a multiplicand, which is a fixed point number represented in two's complement, and a multiplier, which is an (N+1)-bit (where N is an integer of not less than 2) fixed point number represented in two's complement, the multiplication apparatus comprising:
an encoding unit for encoding the multiplier based on a radix-4 Booth's algorithm and outputting a plurality of encoding results obtained;
an overflow detection unit for detecting an occurrence of an overflow when each of the multiplicand and the multiplier is a negative maximum value;
a partial product generation unit for generating a plurality of partial products from the multiplicand and the plurality of encoding results as well as a plurality of correction factors, which correspond to the plurality of individual partial products, to be added to the corresponding partial products and provide respective two's complements of the partial products, correcting any of the plurality of partial products and the plurality of correction factors such that the multiplication result has a positive maximum value when the overflow detection unit detects the occurrence of the overflow, and outputting a result of the correction;
an accumulation unit for performing accumulation of the plurality of partial products and the plurality of correction factors, compressing a result of the accumulation to two intermediate products, and outputting the two intermediate products; and
a final addition unit for performing addition of the two intermediate products and outputting the result of the addition as a multiplication result,
wherein the partial product generation unit includes:
a plurality of first partial product generation circuits for individually receiving the plurality of encoding results except for the most significant and least significant encoding results and performing, based on the multiplicand and the received encoding results, the generation of each of the plurality of partial products corresponding to the received encoding results except for the most significant and least significant partial products and the generation of each of the plurality of correction factors corresponding to the received encoding results except for the most significant and least significant correction factors;
a second partial product generation circuit for performing, based on the multiplicand and the most significant encoding result of the plurality of encoding results, the generation of the most significant partial product of the plurality of partial products and the generation of the most significant correction factor of the plurality of correction factors; and
a third partial product generation circuit for performing, based on the multiplicand and the least significant encoding result of the plurality of encoding results, the generation of the least significant partial product of the plurality of partial products and the generation of the least significant correction factor of the plurality of correction factors,
wherein the second partial product generation circuit outputs 0 as the most significant correction factor when the occurrence of the overflow is detected by the overflow detection unit, and
wherein the third partial product generation circuit outputs 1 as each of lower (N−1) bits of the least significant partial product when the occurrence of the overflow is detected by the overflow detection unit.

11. The multiplication apparatus of claim 10, wherein
the third partial product generation circuit includes:
a plurality of selection circuits each for generating one bit of the least significant partial product in response to the multiplicand and to a selection signal; and
an encoding result correction unit,
wherein an output of the encoding result correction unit is given as the selection signal to each of the (N−1) selection circuits of the plurality of selection circuits which output the lower (N−1) bits of the least significant partial product, while the least significant encoding result is given as the selection signal to each of the other selection circuits, and
wherein the encoding result correction unit outputs a value such that 1 is outputted from each of the selection circuits to which the output of the encoding result correction unit is given in a case where the occurrence of the overflow is detected by the overflow detection unit, while outputting the least significant encoding result in the other cases.

12. The multiplication apparatus of claim 10, wherein
the third partial product generation circuit includes:
a plurality of selection circuits each for generating one bit of the least significant partial product in response to the multiplicand and to a selection signal; and
(N−1) saturation processing circuits corresponding to the respective (N−1) selection circuits of the plurality of selection circuits which output the lower (N−1) bits of the least significant partial product,
wherein each of the plurality of selection circuits uses the least significant encoding result as the selection signal, and
wherein each of the (N−1) saturation processing circuits corrects an output of the corresponding selection circuit of the plurality of selection circuits to 1 and outputs the corrected value in a case where the occurrence of the overflow is detected by the overflow detection unit, while outputting the output of the corresponding selection circuit as it is in the other cases.

13. A multiplication apparatus for generating a product of a multiplicand, which is a fixed point number represented in two's complement, and a multiplier, which is a fixed point number represented in two's complement, the multiplication apparatus comprising:
an encoding unit for encoding the multiplier based on a radix-4 Booth's algorithm and outputting a plurality of encoding results obtained;
an overflow detection unit for detecting an occurrence of an overflow when each of the multiplicand and the multiplier is a negative maximum value;
a partial product generation unit for generating a plurality of partial products from the multiplicand and the plurality of encoding results as well as a plurality of correction factors, which correspond to the plurality of individual partial products, to be added to the corresponding partial products and provide respective two's complements of the partial products, correcting any of the plurality of partial products and the plurality of correction factors such that the multiplication result has a positive maximum value when the overflow detection unit detects the occurrence of the overflow, and outputting a result of the correction;
an accumulation unit for performing accumulation of the plurality of partial products and the plurality of correction factors, compressing a result of the accumulation to two intermediate products, and outputting the two intermediate products; and
a final addition unit for performing addition of the two intermediate products and outputting the result of the addition as a multiplication result,
wherein the partial product generation unit includes:
a plurality of first partial product generation circuits for individually receiving the plurality of encoding results except for the most significant encoding result and performing, between the multiplicand and the received encoding results, the generation of each of the plurality of partial products corresponding to the received encoding results except for the most significant partial product and the generation of each of the plurality of correction factors corresponding to the received encoding results except for the most significant correction factor; and
a second partial product generation circuit for performing, based on the multiplicand and the most significant encoding result of the plurality of encoding results, the generation of the most significant partial product of the plurality of partial products and the generation of the most significant correction factor of the plurality of correction factors,
wherein each of the plurality of first partial product generation circuits outputs a binary number 11 as each of the correction factors to be generated except for the most significant correction factor when the occurrence of the overflow is detected by the overflow detection unit, and
wherein the second partial product generation circuit outputs 0 as the most significant correction factor when the occurrence of the overflow is detected by the overflow detection unit.
